(19) United States
(12) Patent Application Publication
(10) Pub. No.: US 2026/0308774 A1
(43) Pub. Date: Oct. 8, 2026

(54) System and Methods for Controlling Material Synthesis via Electrochemical Reactions

(71) Applicant: Quantom LLC, New Haven, CT (US)

(72) Inventor: Matthew Michael Fawcett, The Hague (NL)

(21) Appl. No.: 19/638,093

(22) Filed: Apr. 2, 2026

Related U.S. Application Data
(60) Provisional application No. 63/783,052, filed on Apr. 3, 2025.

(51) Int. Cl. C25B 1/135; C25B 9/05; C25B 9/65; C25B 15/025

(52) U.S. Cl. CPC C25B 1/135; C25B 9/05; C25B 9/65; C25B 15/025

(57) ABSTRACT

Devices and methods are provided for controlled nucleation and growth of materials in electrochemical environments. The technology utilizes conductive seed materials positioned on or near electrodes to act as nucleation centers for electrochemically generated growth species. By applying pulsed electrical stimulation in the presence of suitable chemical precursors, material formation is initiated at the seed sites and can propagate via self-propagating nucleation, where newly formed material structures serve as additional nucleation centers. This approach enables precise control over material morphology, crystal orientation, porosity, surface area, and dimensional characteristics while improving growth rates and energy efficiency relative to conventional electrochemical synthesis methods. The systems and methods are scalable across various reactor configurations and material types, including carbon-based materials derived from environmentally beneficial feedstocks such as carbon dioxide.

### CROSS-REFERENCE TO RELATED APPLICATIONS

This application claims the benefit of U.S. Provisional Application Ser. No. 63/783,052, filed Apr. 3, 2025, the complete disclosure of which is incorporated herein by reference for all purposes.

### TECHNICAL FIELD

This description generally relates to materials science and electrochemical synthesis methods, and more specifically to systems and methods for controlling material growth through electrochemical reactions utilizing a self-seeding nucleation mechanism.

### BACKGROUND OF THE INVENTION

Electrochemical reduction of carbon dioxide (CO₂) has been widely investigated as a method for producing fuels, chemicals, and other carbon-containing products using electrical energy. In aqueous electrochemical systems, CO₂ reduction reactions (CO₂RR) are typically carried out using metal electrodes such as copper, gold, silver, bismuth, or tin in the presence of aqueous electrolytes. These reactions most commonly produce gaseous or dissolved products, including carbon monoxide, methane, ethylene, ethanol, or formate.

Copper electrodes have received particular attention because they are capable of producing a wide variety of hydrocarbon and oxygenated products. However, the formation of solid carbon deposits on electrode surfaces is generally regarded as undesirable in such systems. Carbon deposition can block catalytic active sites and reduce the efficiency and stability of the electrode. Consequently, many electrochemical CO₂ reduction studies focus on minimizing carbon accumulation and maintaining clean catalytic surfaces.

To address these issues, various operational strategies have been developed to maintain catalyst activity and product selectivity. For example, pulsed electrolysis techniques are frequently used to modify reaction conditions or to remove adsorbed intermediates from electrode surfaces. In many reported systems, pulsed potentials are applied to periodically regenerate or clean the electrode surface rather than to promote the formation of solid carbon structures.

Controlled synthesis of carbon materials has been achieved through other techniques, such as chemical vapor deposition processes that operate at elevated temperatures and rely on gas-phase carbon precursors. Similarly, certain high-temperature molten salt electrolysis systems have demonstrated conversion of carbonate species to carbon materials under molten electrolyte conditions. These approaches operate under substantially different environments from aqueous electrochemical systems, including significantly higher temperatures and different reaction mechanisms.

More broadly, conventional electrochemical material synthesis methods face several technical limitations that restrict their practical deployment. For example, many existing approaches provide limited control over the morphology, spatial distribution, and structural uniformity of synthesized materials. In addition, growth rates in such systems are often relatively slow, resulting in inefficient material production.

Existing electrochemical synthesis processes may also exhibit poor energy efficiency, requiring relatively high electrical input to produce a given quantity of material. Furthermore, processes that perform adequately at laboratory scale frequently encounter scalability challenges when translated to larger systems, where maintaining consistent reaction conditions and material properties becomes difficult.

Environmental considerations present additional concerns in certain synthesis techniques, particularly where hazardous reagents, aggressive electrolytes, or undesirable byproducts are generated during operation.

Accordingly, while electrochemical CO₂ reduction systems have been widely studied for producing gaseous or dissolved products, controlled formation and spatial localization of solid carbon structures in aqueous electrochemical environments remains largely unexplored. Methods capable of directing nucleation and growth of carbon materials on electrode surfaces under aqueous electrochemical conditions would therefore represent a useful advancement in electrochemical material synthesis.

### SUMMARY OF THE INVENTION

The following presents a simplified summary of the claimed subject matter in order to provide a basic understanding of some aspects of the claimed subject matter. This summary is not an extensive overview of the claimed subject matter. It is intended to neither identify critical elements of the claimed subject matter nor delineate the scope of the claimed subject matter. Its sole purpose is to present some concepts of the claimed subject matter in a simplified form as a prelude to the more detailed description that is presented later.

Devices and methods are provided for controlled nucleation and growth of materials within electrochemical environments. The disclosed technology enables precise initiation and propagation of material formation by introducing seed materials that act as nucleation centers for electrochemically generated growth species. Through controlled electrochemical conditions, including pulsed electrical stimulation and tailored precursor chemistries, the system directs material formation at predetermined locations while enabling scalable and energy-efficient production of functional materials.

In various embodiments a conductive seed material positioned on or near an electrode serves as an initiation site for material formation. When an electrical current or potential is applied in the presence of suitable chemical precursors, electrochemical reactions generate growth species that nucleate on the seed material and form solid material structures. In certain embodiments, newly formed material structures themselves function as additional nucleation sites, thereby creating a self-propagating growth process that can substantially accelerate synthesis rates. This self-propagating nucleation mechanism enables improved growth kinetics and reduced energy consumption compared with conventional electrochemical synthesis techniques.

The disclosed systems and methods provide significant advantages over traditional electrochemical material synthesis processes. By selecting the composition, morphology, and spatial distribution of the seed material, the resulting material structure can be controlled with high precision. Such control enables manipulation of crystal orientation, porosity, surface area, and dimensional characteristics of the synthesized material. In addition, the self-propagating nucleation mechanism enables substantially accelerated material growth rates while maintaining efficient energy utilization. The methods are adaptable across a wide range of material systems and reactor configurations, facilitating scalability to industrial manufacturing processes including batch processing, continuous flow reactors, roll-to-roll fabrication, and multi-stage production systems. The disclosed systems may operate across a broad range of temperatures, including from about 0° C. to about 400° C., enabling synthesis under aqueous, non-aqueous, and hybrid electrochemical conditions.

In particular, operation within intermediate temperature regimes between about 80° C. and about 400° C. enables electrochemical material formation in electrolyte systems that do not require molten salts, thereby providing an alternative to high-temperature molten salt processes while maintaining controlled nucleation behavior through the seed-directed mechanism described herein. In certain embodiments, environmentally beneficial feedstocks such as carbon dioxide obtained from ambient air or industrial emissions may be utilized as chemical precursors, thereby reducing environmental impact while producing valuable carbon-based materials.

In one aspect, a method of synthesizing a material is provided. The method includes depositing a conductive seed material onto, or in proximity with, an electrode within an aqueous electrochemical reactor, introducing into the reactor an aqueous electrolyte containing one or more chemical precursors capable of forming a solid material, applying a pulsed electrical current or potential to the electrode to convert the chemical precursors into material growth species, and nucleating the material growth species on the activated seed material such that the activated seed material initiates growth of the solid material.

In embodiments, the method further comprises activating the seed material by applying a pre-pulse electrical treatment to the electrode. The pre-pulse has a magnitude and duration selected to modify the chemical or electronic state of the seed material to enhance its nucleation activity without initiating significant bulk deposition on the electrode.

In embodiments, the material growth species forms additional nucleation sites that promote continued growth of the solid material, thereby enabling a self-propagating growth mechanism that can substantially increase synthesis rates. This cascading nucleation behavior enables a self-propagating material growth process capable of producing materials with controlled morphology and improved synthesis efficiency.

Unlike conventional electrodeposition, where material growth proceeds uniformly across the electrode surface without preferential spatial localization, the self-seeding nucleation mechanism described herein produces growth that is substantially confined to regions where seed material has been deposited. This spatial selectivity, quantified by the selectivity metric S, demonstrates that the deposited material preferentially nucleates at seed sites rather than propagating uniformly from the electrode surface. Furthermore, the self-propagating aspect of SSN, where newly deposited material exhibits nucleation activity comparable to the original seed, is mechanistically distinct from bulk overgrowth, which does not exhibit this cascading acceleration behavior.

In embodiments, the seed material comprises a carbon-based material. The carbon-based material may comprise graphene, graphene oxide, carbon nanotubes, carbon fibers, graphite, nanodiamonds, or combinations thereof.

In embodiments, the seed material comprises a conductive metal. The conductive metal may comprise platinum, gold, silver, copper, or combinations thereof.

In certain embodiments, the electrochemical synthesis process may involve conversion of carbon-containing gaseous precursors, such as carbon dioxide, into carbon growth species at the surface of a conductive electrode. For example, carbon dioxide introduced into the electrochemical reactor may undergo electrochemical reduction at a metal electrode, including electrodes comprising gold, copper, silver, platinum, or combinations thereof. Under suitable electrochemical conditions, the reduction of the carbon-containing precursor may generate reactive carbon species that nucleate on the seed material and initiate growth of carbon-based materials through the self-seeding nucleation mechanism described herein. In some implementations, a gold electrode may serve as a substrate or catalytic surface that promotes formation of carbon growth species from carbon dioxide, which subsequently nucleate on carbon-based seed materials such as graphene oxide or related carbon structures to initiate controlled material growth.

In embodiments, the seed material comprises a semiconductor. The semiconductor may comprise silicon, germanium or combinations thereof.

In embodiments, the electrochemical reaction may be driven using a pulsed electrical current or potential applied to one or more electrodes within the electrochemical reactor. The pulsed electrical bias may comprise alternating intervals of relatively higher bias and relatively lower bias, which together form a repeating pulse sequence. The use of pulsed electrical stimulation can influence the electrochemical environment at the electrode surface, including the generation of reactive species, nucleation behavior, and growth kinetics of the synthesized material. By periodically varying the applied bias, the system can promote controlled nucleation at the seed material while regulating subsequent material growth, thereby improving morphological control and overall synthesis efficiency.

In embodiments, the higher-bias intervals and lower-bias intervals may differ in magnitude so as to create alternating electrochemical conditions at the electrode surface. The higher-bias interval may comprise a bias magnitude within a first specified range, while the lower-bias interval may comprise a bias magnitude within a second range different from the first. The difference between the higher- and lower-bias intervals may be selected to promote formation of material growth species during one portion of the pulse cycle and stabilization or controlled deposition during another portion of the cycle. In certain implementations, the potential difference between the higher- and lower-bias intervals may range from approximately 0.1 V to approximately 0.5 V versus a reference electrode. In other implementations, the pulsed bias may be characterized by differences in current density between intervals, for example between about 5 mA/cm² and about 40 mA/cm². The relative magnitude of the higher-bias interval may also be expressed as a multiple of the lower-bias interval, such as between approximately 1.1 and 2.5 times the magnitude of the lower-bias interval.

In embodiments, the pulsed electrical bias may further be characterized by the duration of the higher-bias and lower-bias intervals. Each interval may have a duration selected to promote desired nucleation and growth behavior at the seed material. For example, higher-bias intervals may facilitate formation of reactive growth species, while lower-bias intervals may allow stabilization, attachment, or restructuring of the growing material. In certain embodiments, the duration of each interval may range from approximately 0.1 seconds to approximately 10 seconds, although other pulse durations may be employed depending on the material system and reactor configuration.

In embodiments, the pulsed electrical bias may include pulse cycles having durations within a range of approximately 0.1 seconds to approximately 10 seconds. The applied electrical conditions may include potentials within a range of approximately 1.5 V to approximately 5.0 V relative to a reference electrode. In certain implementations, the electrochemical reaction may be controlled using current densities ranging from approximately 5 mA/cm² to approximately 40 mA/cm². These electrical operating parameters may be adjusted to regulate nucleation density, growth rate, morphology, and structural characteristics of the resulting material.

In embodiments, the electrochemical reactor may operate over a range of temperatures and pressures depending on the material system, electrolyte composition, and desired reaction kinetics. For example, the reactor may operate at temperatures ranging from about 0° C. to about 400° C., including sub-ambient, ambient, and elevated temperature regimes. In certain embodiments, the reactor operates between about 20° C. and about 250° C., while in other embodiments the reactor operates between about 80° C. and about 400° C. in non-molten-salt electrolyte systems.

In embodiments, the reactor may operate at temperatures from about 0° C. to about 400° C., or about 10° C. to about 350° C., or about 20° C. to about 250° C., or about 20° C. to about 200° C., or about 20° C. to about 100° C., or about 20° C. to about 80° C. In some embodiments, the reactor may operate at temperatures from about 40° C. to about 65° C., or about 80° C. to about 400° C. Operating temperature may influence reaction rates, precursor solubility, nucleation behavior, and growth morphology of the synthesized material. Temperature control systems may therefore be incorporated into the reactor to maintain desired operating conditions and enable consistent material synthesis across different process configurations.

The reactor may operate at pressures in the range of about 0.1-200 bar, or about 1 bar to about 1.5 bar, or about 1 bar to about 40 bar, or about 2 bar to about 40 bar. Operating pressure may influence reaction rates, precursor solubility, nucleation behavior, and growth morphology of the synthesized material. In certain embodiments, the reactor operates between about 1 bar and about 20 bar to increase solubility of gaseous precursors such as carbon dioxide or hydrocarbons. In further embodiments, the reactor operates under supercritical conditions, including supercritical carbon dioxide at pressures above about 73 bar and temperatures above about 31° C. Operating pressure may influence precursor solubility, mass transport, nucleation behavior, and growth morphology of the synthesized material.

In embodiments, the electrolyte comprises an aqueous electrolyte, an organic electrolyte, an ionic liquid electrolyte, a deep eutectic solvent, a polymer or gel electrolyte, or combinations thereof.

In certain embodiments, the electrolyte comprises an aqueous electrolyte containing dissolved salts selected from bicarbonates, carbonates, sulfates, phosphates, chlorides, or combinations thereof, with concentrations ranging from about 0.01 M to about 10 M, or about 0.1 to about 1.0M, including alkaline, acidic, neutral, and buffered systems.

In other embodiments, the electrolyte comprises a non-aqueous organic solvent selected from acetonitrile, dimethylformamide, dimethyl sulfoxide, propylene carbonate, ethylene carbonate, tetrahydrofuran, or combinations thereof containing dissolved supporting electrolyte salts.

In further embodiments, the electrolyte comprises an ionic liquid including imidazolium-based, pyrrolidinium-based, ammonium-based, or phosphonium-based ionic liquids. Such ionic liquids may be liquid at or near room temperature and are compositionally distinct from high-temperature molten salts.

In still further embodiments, the electrolyte comprises a deep eutectic solvent formed from hydrogen bond donor and acceptor components, including choline chloride-urea, choline chloride-ethylene glycol, choline chloride-glycerol, or combinations thereof.

In additional embodiments, the electrolyte comprises polymer or gel-based systems including polyvinyl alcohol (PVA)-based electrolytes, Nafion-based systems, hydrogels, or solid polymer electrolytes.

In certain implementations, mixed electrolyte systems may be used, including aqueous-organic mixtures, aqueous-ionic liquid mixtures, or ionic liquid-organic solvent mixtures.

In certain embodiments, the electrolyte excludes high-temperature molten inorganic salts operated above about 450° C., such that material formation is achieved through seed-directed electrochemical nucleation in non-molten or low-temperature electrolyte systems.

In embodiments, the electrolyte comprises one or more chemical precursors capable of forming a solid material through electrochemical reduction, oxidation, or electrochemically induced reactions. The chemical precursors may be present in dissolved, suspended, dispersed, gaseous, or particulate form within the electrolyte. In certain embodiments, the chemical precursor comprises carbon-containing precursors including carbon dioxide, carbon monoxide, carbonate species, bicarbonate species, graphene oxide precursors, graphite oxide precursors, carbon nanotube precursors, polymeric carbon precursors, sucrose, phenolic resins, polyacrylonitrile, hydrocarbons, alcohols, or combinations thereof. In other embodiments, the chemical precursor comprises metal-containing precursors including dissolved metal salts, metal ions, metal complexes, organometallic compounds, or combinations thereof capable of forming conductive or semiconductive materials. In further embodiments, the chemical precursor comprises semiconductor precursors including silicon-containing compounds, germanium-containing compounds, or combinations thereof.

In certain implementations, gaseous precursors including carbon dioxide may be introduced into the electrochemical reactor through a gas inlet and dissolved or reacted within the electrolyte. The chemical precursors may therefore include precursors suitable for producing carbon materials, metal materials, semiconductor materials, composite materials, porous materials, or combinations thereof. In such embodiments, nucleation and growth of carbon-based materials occur through interaction with the seed material rather than through metal-catalyzed carbide formation mechanisms.

In embodiments, the seed material is electrically connected to the electrode such that the seed material participates directly in the electrochemical reaction occurring within the reactor. Electrical connection may be achieved through direct deposition of the seed material onto a conductive electrode surface, through conductive traces, or through intermediate conductive layers or contact pads. When electrically connected, the seed material can experience the local electrochemical potential applied to the electrode, thereby enabling nucleation of material growth species directly on the seed surface. This configuration can promote preferential nucleation at the seed locations and facilitate controlled initiation of the self-propagating growth mechanism described herein.

In embodiments, the seed material may be patterned on the electrode surface in order to localize nucleation and growth of the synthesized material. Patterning the seed material enables spatial control over where material growth occurs within the electrochemical reactor. Such patterning may be achieved through a variety of techniques including lithographic patterning, masking processes, printing methods, laser patterning, or other microfabrication or deposition techniques capable of defining discrete seed regions on an electrode surface. By selectively positioning seed regions, material growth can be directed to predetermined locations while other areas of the electrode remain substantially free of nucleation.

In embodiments, the seed material is deposited in a predetermined pattern comprising a plurality of discrete seed features separated by regions that are substantially free of seed material. The seed features may be electrically connected to the electrode through conductive traces or direct contact with the electrode surface. When the electrochemical reaction is initiated, nucleation of the material occurs predominantly at the seed features due to their electrical connectivity and catalytic or structural properties. The separation between seed features allows controlled spatial isolation of nucleation events, enabling investigation or optimization of growth conditions while also providing a mechanism for controlled placement of synthesized materials.

In embodiments, the seed features may comprise a variety of geometries including rings, stripes, circular pads, grids, lattices, dots, or other patterned structures. The geometry of the seed features can influence the morphology and propagation of the resulting material growth. For example, elongated seed features such as stripes may promote directional growth, while circular or ring-shaped features may promote radial nucleation and branching growth patterns. The size, spacing, and orientation of the seed features may therefore be selected to influence the resulting material morphology and growth dynamics.

In embodiments, each seed feature is electrically connected to the electrode such that each feature is capable of independently participating in the electrochemical reaction. Electrical connectivity ensures that the applied potential or current can reach each seed feature, thereby enabling nucleation and subsequent growth of the material at those locations. In certain implementations, electrically connected seed features may be arranged alongside control regions that are not electrically connected to the electrode. Such control regions may include seed material that is physically present but electrically isolated from the electrode, allowing comparison between electrically active and electrically inactive seed regions. This configuration can be used to evaluate the role of electrical connectivity in initiating nucleation and self-propagating growth processes.

In certain embodiments, patterned seed structures may include both electrically connected seed regions and electrically isolated seed regions positioned on the same substrate. The electrically connected seed regions may function as active nucleation sites during the electrochemical reaction, while the electrically isolated regions may serve as control structures to verify that nucleation and growth are driven by electrochemical activation rather than passive deposition or other non-electrochemical processes. Such patterned arrangements can be particularly useful for experimental validation, optimization of process parameters, and characterization of the self-seeding nucleation mechanism.

In another aspect, an electrochemical reactor for synthesizing a material is provided. The reactor may include a reaction chamber configured to contain an electrochemical environment, one or more electrodes positioned within the chamber, and a conductive seed material disposed on or in proximity to at least one of the electrodes. The reactor may further include a delivery system configured to introduce an electrolyte containing one or more chemical precursors capable of forming a solid material. A power supply or electrical control system may be coupled to the electrodes and configured to apply an electrical current or potential to initiate electrochemical reactions that generate material growth species. These growth species may nucleate on the seed material and initiate formation of the synthesized material through the self-seeding nucleation mechanism described herein.

In embodiments, the electrical control system is configured to apply a pulsed electrical current or potential to the electrode. The pulsed electrical bias may include alternating intervals of relatively higher bias and relatively lower bias that produce varying electrochemical conditions at the electrode surface. Such pulsed operation may facilitate controlled formation of reactive species, promote nucleation at the seed material, and regulate subsequent growth of the synthesized material.

In embodiments, the magnitude of the higher-bias intervals differs from that of the lower-bias intervals. For example, the potential difference between the intervals may be within a range of approximately 0.1 V to approximately 0.5 V relative to a reference electrode. In other embodiments, the difference between the intervals may be expressed in terms of current density, such as a difference of approximately 5 mA/cm² to approximately 40 mA/cm². In further embodiments, the higher-bias interval may have a magnitude between approximately 1.1 and approximately 2.5 times the magnitude of the lower-bias interval.

In embodiments, the pulsed electrical bias may be further defined by the duration of the higher-bias and lower-bias intervals. Each interval may have a duration selected to influence nucleation dynamics and growth behavior of the synthesized material. For example, the intervals may have durations ranging from approximately 0.1 seconds to approximately 10 seconds, although other pulse durations may be used depending on the reactor configuration and material system.

In embodiments, the electrode may include patterned seed features arranged on its surface. The seed features may be separated by regions substantially free of seed material, enabling localized nucleation and spatial control of material growth. The seed features may be electrically connected to the electrode through conductive traces or direct contact with the electrode surface so that each seed feature participates in the electrochemical reaction.

In embodiments, the seed features may have various geometries selected to influence nucleation and growth behavior. Example geometries may include rings, stripes, circular pads, grids, dots, lattices, or other patterned structures. The size, spacing, and arrangement of the seed features may be selected to control nucleation density, growth orientation, and morphological characteristics of the synthesized material.

In embodiments, the reactor may further include systems configured to apply external fields to the electrochemical environment. Such systems may include acoustic field generators, magnetic field generators, electric field generators, or combinations thereof. These external fields may influence mass transport, nucleation behavior, or structural organization of the growing material.

In embodiments, the reactor may include a gas inlet configured to introduce gaseous precursors into the reaction chamber. For example, carbon dioxide may be introduced from ambient air through a direct air capture system or from industrial emissions or flue gases. The introduced gas may dissolve into the electrolyte or participate directly in electrochemical reactions that produce material growth species.

In embodiments, the reactor may operate under a range of electrical and thermal conditions suitable for the selected material system. For example, the reactor may operate at temperatures ranging from about 0° C. to about 400° C., or about 10° C. to about 350° C., or about 20° C. to about 250° C., or about 20° C. to about 200° C., or about 20° C. to about 100° C., or about 20° C. to about 80° C. In some embodiments, the reactor may operate at temperatures from about 40° C. to about 65° C., or about 80° C. to about 400° C. Operating temperature may influence reaction rates, precursor solubility, nucleation behavior, and growth morphology of the synthesized material. Temperature control systems may therefore be incorporated into the reactor to maintain desired operating conditions and enable consistent material synthesis across different process configurations.

The reactor may operate at pressures in the range of about 0.1-200 bar, or about 1 bar to about 1.5 bar, or about 1 bar to about 40 bar, or about 2 bar to about 40 bar. Operating pressure may influence reaction rates, precursor solubility, nucleation behavior, and growth morphology of the synthesized material.

The applied electrical conditions may include potentials between approximately 1.5 V and approximately 5.0 V relative to a reference electrode or current densities between approximately 5 mA/cm² and approximately 40 mA/cm². These operating parameters may be adjusted to regulate reaction kinetics, nucleation behavior, and resulting material properties.

In another aspect, a material produced using the electrochemical synthesis methods described herein is provided. The material may be formed through electrochemical nucleation and growth initiated at a conductive seed material and propagated through the self-seeding growth mechanism described above. Materials produced using this approach may exhibit controlled morphology, tunable structural properties, and improved growth efficiency compared with materials produced using conventional electrochemical synthesis techniques.

In embodiments, the seed material that initiates nucleation may comprise a carbon-based material, a conductive metal, a semiconductor material, or combinations thereof.

In embodiments, the synthesized material may comprise carbon-based materials including graphene, graphene oxide, carbon nanotubes, carbon fibers, graphite, porous carbon structures, nanodiamonds, or combinations thereof.

In embodiments, the seed material may include conductive metals such as platinum, gold, silver, copper, or combinations thereof.

In embodiments, the seed material may include semiconductor materials such as silicon, germanium, or related semiconductor compositions.

In embodiments, the materials produced by the disclosed methods may exhibit controlled structural characteristics including tunable morphology, crystallinity, porosity, dimensional properties, and electrical conductivity depending on the selected seed material, precursor chemistry, and electrochemical operating conditions.

The recitation herein of desirable objects which are met by various embodiments of the present description is not meant to imply or suggest that any or all of these objects are present as essential features, either individually or collectively, in the most general embodiment of the present description or any of its more specific embodiments.

### BRIEF DESCRIPTION OF THE DRAWINGS

The accompanying drawings, which are incorporated in and constitute a part of this specification, illustrate several embodiments of the disclosure and together with the description, explain the principles of the disclosure.

FIG. 1 is a schematic diagram of an electrochemical reactor system for self-seeding nucleation;

FIG. 2 schematically illustrates a process of self-seeding nucleation for synthesizing a material;

FIG. 3 is a graph comparing growth rates of a material for conventional material synthesis processes and a material synthesis process described herein;

FIG. 4 illustrates microstructural characteristics of two representative materials synthesized by the systems and methods described herein;

FIG. 5 is a schematic of a system and method for synthesizing a material described herein; and

FIG. 6 is a schematic illustration of an electrode with conductive seed materials positioned to initiate and direct material growth within an electrochemical reactor.

### DETAILED DESCRIPTION OF THE EMBODIMENTS

This description illustrates exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Systems and methods are provided for controlled material synthesis through electrochemical reactions and, more specifically, to a self-seeding nucleation process that enables precise control over material growth, morphology, and properties. The materials may include, without limitation, carbon-based materials, metals, semiconductors, and composite materials. Carbon-based materials may include graphene, reduced or oxidized graphene, graphene oxide, carbon nanotubes, carbon fibers, graphite, activated carbon, nanodiamonds, and porous carbon structures, as well as combinations or functionalized derivatives thereof. Metal materials may include conductive metals such as platinum, gold, silver, copper, nickel, and alloys or mixtures thereof. Semiconductor materials may include silicon, germanium, or other Group IV, III-V, or II-VI semiconductors, either in elemental, crystalline, polycrystalline, or amorphous forms. Composite materials may include hybrid structures combining carbon-based materials with metals or semiconductors, or combinations of different carbon allotropes.

In certain embodiments, the materials produced may have controlled morphology, dimensions, porosity, crystallinity, or surface functionalization, as determined by the characteristics of the seed material, electrochemical parameters, and applied external fields. The systems and methods may form layered, tubular, fibrous, porous, or patterned structures, as well as multi-material architectures, all synthesized under the self-seeding nucleation process. The systems and methods are applicable to material production from precursors derived from gaseous, aqueous, or solid feedstocks, including, without limitation, carbon dioxide captured from ambient air or industrial emissions, metal salts, organometallic compounds, and other electrochemically active species.

In certain embodiments, the controlled material synthesis is directed specifically to carbon-based products derived from CO₂ electroreduction. Unlike conventional approaches that may regard carbon deposition on electrodes as undesirable fouling, the present methods intentionally promote the formation of structured carbon at predefined seed sites. By integrating pre-pulse activation, pulsed potential regimes, and controlled reaction conditions, the invention enables reproducible, spatially selective growth of graphene, reduced graphene oxide, or other carbon allotropes with desired morphology and properties.

As used herein, the term ‘electrolyte’ encompasses aqueous, organic, ionic liquid, deep eutectic solvent, polymer, and gel electrolyte systems that are liquid or quasi-liquid below approximately 200° C. without requiring thermal decomposition of inorganic salt components. The electrolyte systems described herein are distinguished from high-temperature molten inorganic salt electrolytes, which are characterized by melting points above approximately 300° C., ionic conduction through fully dissociated inorganic ions, and operation at temperatures typically above 450° C. Room-temperature ionic liquids, which are organic salts with melting points below 100° C. and which conduct through organic cation-anion pairs, fall within the scope of the present electrolyte systems.

As shown in FIG. 2, the systems and methods generally include depositing a seed material onto, or in proximity with, an electrode within an electrochemical reactor and applying an electrical current or potential to induce material growth. The seed material acts as an initial nucleation site, and the newly formed material serves as additional nucleation points, creating a self-propagating, exponential growth mechanism. This approach offers significant advantages over conventional methods, including enhanced morphological control, accelerated growth rates, improved energy efficiency, versatility across diverse material systems, and reduced environmental impact.

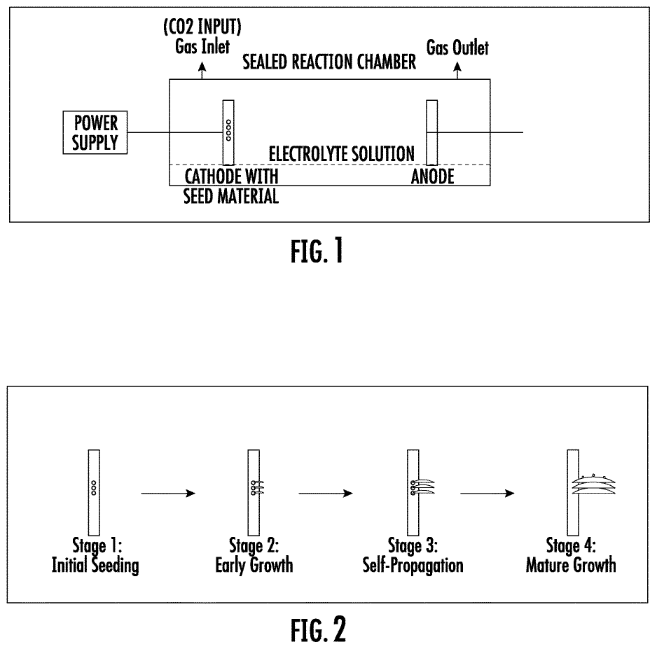

In certain embodiments, the self-seeding nucleation method comprises three principal components: (a) Seed Material Deposition, in which a seed material is deposited directly onto, or in close proximity to, an electrode within an electrochemical reactor. Suitable seed materials include, without limitation, carbon-based materials such as graphene, graphene oxide, carbon nanotubes, carbon fibers, graphite, and nanodiamonds; conductive metals such as platinum, gold, silver, or copper; semiconductors such as silicon or germanium; or composite materials combining any of the foregoing. The seed material acts as the initial nucleation site and substantially influences the morphology, crystallinity, and functional properties of the resulting material. (b) Electrochemical Reaction, in which an electrolyte solution containing precursor species is introduced into the reactor, and an electrical current or potential is applied to drive reduction or oxidation reactions at the electrode surfaces. The reaction chemistry may be tailored to generate a wide variety of materials, including carbon-based, metallic, semiconducting, or composite structures. In some embodiments, CO₂ from ambient air, industrial emissions, or other sources may serve as a feedstock for carbon-based materials, providing both environmental and economic benefits. (c) Self-Propagating Nucleation, in which the material species generated by the electrochemical reaction nucleate on the deposited seed material, and each newly formed site functions as an additional growth seed. This self-seeding nucleation mechanism is distinct from conventional electrochemical deposition processes in that the deposited material itself functions as a subsequent nucleation scaffold, enabling cascading growth without reliance on metal catalyst particles or carbide-forming intermediates. This creates a self-propagating, exponential growth mechanism, enabling accelerated growth rates, improved energy efficiency, and precise control over morphology and material properties, as illustrated in FIGS. 1 and 2. This three-component process provides broad applicability across diverse material systems while maintaining tunable control of structural and functional characteristics.

In embodiments, the seed material may include a variety of conductive, semi-conductive, or carbon-based materials. Suitable carbon-based seed materials include graphene, graphene oxide, carbon nanotubes, carbon fibers, graphite, nanodiamonds, and combinations thereof. Conductive metals such as platinum, gold, silver, and copper may also serve as seed materials, while semiconductors such as silicon or germanium are also contemplated. The seed material may be deposited directly on the electrode surface or positioned in close proximity to enable efficient electrochemical coupling. The seed material may be electrically connected to the electrode or patterned in discrete features, such as rings, stripes, or circular pads, to localize nucleation of the material. In certain embodiments, the seed features are electrically connected to allow participation in the electrochemical reaction, while control regions without electrical connection may be used to assess seeded-versus-unseeded growth.

In certain embodiments, the seed material is activated prior to the primary deposition process through a pre-pulse electrical treatment. The pre-pulse may include applying a potential sufficient to reduce graphene oxide (GO) seed sites to reduced graphene oxide (rGO), or to otherwise modify the chemical or electronic state of the seed to enhance its nucleation activity. The pre-pulse can be applied for a selected duration and magnitude, optimized to selectively activate seed sites without initiating significant bulk deposition on the electrode. By performing this activation step, subsequent electrochemical reactions are directed preferentially to the seed sites, promoting controlled nucleation and growth at desired locations.

Spatial selectivity of material deposition may be quantified by a selectivity metric, S, defined as the ratio of material deposited at activated seed sites to material deposited at unseeded regions of the electrode, i.e., S=(mass or coverage on-seed)/(mass or coverage off-seed). In certain embodiments, the methods aim to achieve S≥10, indicating that deposition is highly concentrated at the seed sites relative to unseeded regions. This quantitative measure enables objective evaluation of the effectiveness of the pre-pulse, pulsed potential, and process condition strategies in achieving controlled nucleation and growth.

Following activation of the seed material, a pulsed potential regime may be applied to control material deposition. In this regime, the applied potential alternates between an ON state, during which electrochemical reduction and material growth occur predominantly at the activated seed sites, and an OFF state, during which deposition is suppressed on non-seeded areas. The duty cycle, pulse amplitude, and frequency may be adjusted to optimize selective nucleation and growth, thereby enhancing spatial control of material formation on the electrode. Such pulsed control enables precise regulation of morphology, thickness, and uniformity of the deposited material.

In certain embodiments, the self-seeding nucleation method may be implemented in a stepwise manner for the synthesis of specific materials. For example, in the synthesis of graphene, a seed material such as graphene oxide flakes may be deposited on a conductive cathode. The cathode is then positioned in an electrochemical reactor in proximity to an anode, and an electrolyte solution containing precursor species is introduced. Upon application of a controlled electrical current or potential, the precursor species undergo electrochemical conversion, and reduced graphene nucleates on the seed material. Newly formed graphene layers may themselves serve as additional nucleation sites, resulting in a self-propagating growth mechanism. Process parameters such as electrical current, voltage, temperature, electrolyte composition, and reaction time may be continuously monitored and adjusted to achieve desired thickness, crystallinity, or lateral dimensions. Once the target material properties are achieved, the current is terminated, and the product may be recovered from the electrode for further processing or use.

The method is not limited to graphene and may be applied to a variety of carbon-based materials, metals, semiconductors, and composites. Seed materials may include graphene, graphene oxide, carbon nanotubes, carbon fibers, graphite, nanodiamonds, or conductive metals and semiconductors.

Electrolytes may comprise aqueous, non-aqueous, ionic liquid, deep eutectic solvent, polymer, gel, or mixed electrolyte systems. Aqueous electrolytes may include alkaline, acidic, neutral, or buffered solutions having solute concentrations ranging from approximately 0.01 M to approximately 10 M. Non-aqueous electrolytes may include organic solvents such as acetonitrile, dimethylformamide, dimethyl sulfoxide, propylene carbonate, ethylene carbonate, tetrahydrofuran, or combinations thereof.

In certain embodiments, the electrolyte comprises an ionic liquid including imidazolium-based, pyrrolidinium-based, ammonium-based, or phosphonium-based ionic liquids. Such ionic liquids are organic salts that are liquid at or near room temperature and are compositionally distinct from high-temperature molten inorganic salts.

In further embodiments, the electrolyte comprises a deep eutectic solvent formed from hydrogen bond donor and acceptor components, including choline chloride-urea, choline chloride-ethylene glycol, choline chloride-glycerol, or combinations thereof.

In additional embodiments, polymer or gel electrolytes may be used, including polyvinyl alcohol (PVA)-based systems, Nafion-based systems, hydrogels, or solid polymer electrolytes.

Mixed electrolyte systems may also be used, including aqueous-organic mixtures, aqueous-ionic liquid mixtures, ionic liquid-organic mixtures, or combinations thereof.

The process may be conducted under batch, continuous flow, or roll-to-roll conditions and may incorporate temperature control, pulsed electrical signals, applied pressure, and external fields to further tune morphology, crystallinity, or functional properties. Operating conditions may include temperatures ranging from approximately 0° C. to approximately 400° C. and pressures ranging from approximately 0.1 bar to approximately 200 bar absolute. In certain embodiments, operation between approximately 80° C. and approximately 400° C. is achieved using non-molten-salt electrolytes, enabling electrochemical material synthesis outside of conventional high-temperature molten salt systems.

In certain embodiments, the electrochemical system operates in electrolyte systems that exclude high-temperature molten inorganic salts operated above approximately 450° C. In contrast to molten salt electrolysis processes that rely on metal-catalyzed or carbide-mediated nucleation mechanisms at temperatures typically above 600° C., the present systems utilize seed-directed nucleation in non-molten or low-temperature electrolyte environments. Material growth is initiated and propagated through interaction with pre-deposited seed materials, including carbon-based seed structures, rather than through metal catalyst particles or carbide intermediates.

In embodiments, the electrochemical reactor may operate over a range of temperatures and pressures depending on the material system, electrolyte composition, and desired reaction kinetics. For example, the reactor may operate at temperatures ranging from about 0° C. to about 400° C., including sub-ambient, ambient, and elevated temperature regimes. In certain embodiments, the reactor operates between about 20° C. and about 250° C., while in other embodiments the reactor operates between about 80° C. and about 400° C. in non-molten-salt electrolyte systems.

In embodiments, the reactor may operate at temperatures from about 0° C. to about 400° C., or about 10° C. to about 350° C., or about 20° C. to about 250° C., or about 20° C. to about 200° C., or about 20° C. to about 100° C., or about 20° C. to about 80° C. In some embodiments, the reactor may operate at temperatures from about 40° C. to about 65° C., or about 80° C. to about 400° C. Operating temperature may influence reaction rates, precursor solubility, nucleation behavior, and growth morphology of the synthesized material. Temperature control systems may therefore be incorporated into the reactor to maintain desired operating conditions and enable consistent material synthesis across different process configurations.

The reactor may operate at pressures in the range of about 0.1-200 bar, or about 1 bar to about 1.5 bar, or about 1 bar to about 40 bar, or about 2 bar to about 40 bar. Operating pressure may influence reaction rates, precursor solubility, nucleation behavior, and growth morphology of the synthesized material. In certain embodiments, the reactor operates between about 1 bar and about 20 bar to increase solubility of gaseous precursors such as carbon dioxide or hydrocarbons. In further embodiments, the reactor operates under supercritical conditions, including supercritical carbon dioxide at pressures above about 73 bar and temperatures above about 31° C. Operating pressure may influence precursor solubility, mass transport, nucleation behavior, and growth morphology of the synthesized material.

The stepwise implementation provides enhanced growth rates, improved energy efficiency, reduced environmental impact, and precise morphological control relative to conventional synthesis methods.

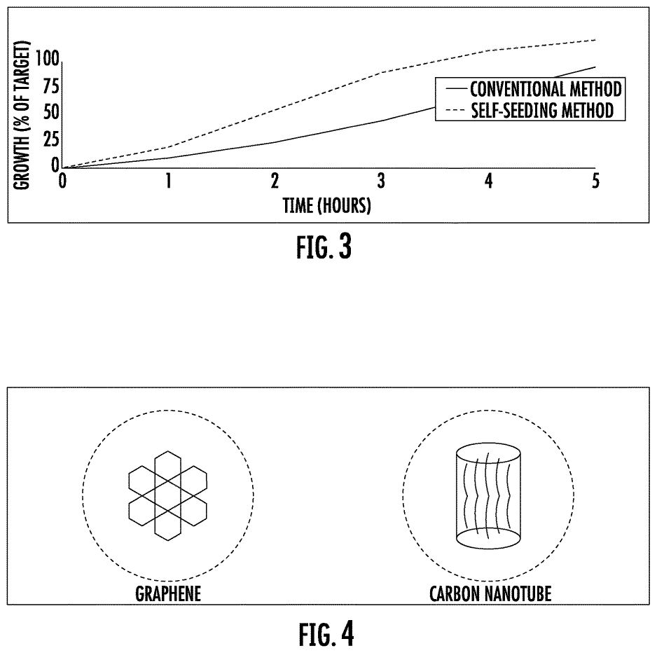

As shown in FIG. 3, illustrative experimental data, the self-seeding nucleation method achieves a 2.66× increase in graphene growth rate and a 1.66× improvement in energy efficiency relative to conventional methods. Similar improvements have been observed for other carbon-based materials, including carbon nanotubes, carbon fibers, porous carbon, and graphite, demonstrating the broad applicability and scalability of the process. By combining seed-mediated growth with tunable electrochemical parameters, the method enables the synthesis of high-quality carbon materials from diverse precursor sources, including carbon dioxide captured from ambient air or industrial emissions. Microstructural analysis of the resulting graphene sheets and carbon nanotubes is illustrated in FIG. 4, demonstrating controlled layer formation and defect density.

The electrochemical reactor (schematically illustrated in FIG. 1) may comprise one or more electrodes within a sealed reaction chamber, an electrolyte solution reservoir, gas inlet and outlet ports, a power supply, and integrated systems for temperature control and byproduct management. Electrolytes may be aqueous or non-aqueous and may contain precursors for a broad range of materials, including graphene oxide, carbon nanotubes, carbon fibers, graphite, and porous carbon structures. In some embodiments, carbon dioxide from ambient air (via direct air capture) or from industrial emissions is utilized as a feedstock for carbon-based material synthesis. The reactor configuration may support batch processing, continuous flow operations, roll-to-roll manufacturing, or multi-stage industrial implementations.

In some embodiments, the electrochemical reaction conditions, including CO₂ delivery rate and solution temperature, are controlled to further favor deposition at activated seed sites. By modulating CO₂ flux, local supersaturation of reactive intermediates at seed sites can be enhanced, while suppressing nucleation in unseeded areas. Temperature may be maintained within a range that promotes selective nucleation without significant spontaneous bulk deposition. These process parameters, in combination with pre-pulse activation and pulsed potential, provide an integrated approach for highly selective material synthesis.

The electrochemical reaction may be driven by either reduction or oxidation processes and may be enhanced by applying pulsed electrical currents or potentials. Pulsed operation may involve alternating higher-bias and lower-bias intervals, with the higher-bias intervals having a magnitude approximately 1.1 to 2.5 times greater than the lower-bias intervals. The potential difference between higher- and lower-bias intervals may range from about 0.1 V to about 0.5 V versus a reference electrode, while corresponding current density differences may range from about 5 mA/cm² to about 40 mA/cm². Pulse durations may range from approximately 0.1 seconds to 10 seconds, with duty cycles and total delivered charge adjustable to optimize material growth and seed selectivity. The applied voltage may range from about 1.5 V to about 5.0 V versus a reference electrode, and the current density may range from approximately 5 mA/cm² to 40 mA/cm². The electrochemical reaction may be conducted over a temperature range of about 20° C. to 250° C., and one or more external fields—including electric, magnetic, or acoustic fields—may be applied to influence nucleation and growth orientation.

In the context of this description, a pulsed electrical bias refers to an electrical driving signal applied to one or more electrodes in the electrochemical reactor that varies as a function of time between at least two electrical states. These states may include a relatively higher electrical bias and a relatively lower electrical bias that repeat in a cyclic or periodic sequence. The electrical bias may be expressed in terms of applied potential, current, current density, charge delivery, or combinations thereof. In some implementations the pulsed electrical bias is applied relative to a reference electrode, while in other implementations the electrical conditions may be defined by a controlled current or current density supplied between a working electrode and a counter electrode.

The pulsed electrical bias may include alternating higher-bias intervals and lower-bias intervals. As used herein, a higher-bias interval refers to a portion of the pulse sequence during which the applied potential or current is relatively greater in magnitude than during a corresponding lower-bias interval. The higher-bias interval may promote the formation of reactive intermediates, ions, radicals, or other material growth species in the electrochemical environment. The lower-bias interval may reduce the driving force of the electrochemical reaction and may allow stabilization, attachment, diffusion, restructuring, or ordering of the growing material on the seed surface. Alternating between these electrochemical conditions can influence nucleation density, growth kinetics, and morphology of the synthesized material.

In certain embodiments, the magnitude of the higher-bias interval may be between approximately 1.1 and approximately 2.5 times the magnitude of the lower-bias interval. The difference between the higher-bias and lower-bias intervals may correspond to a potential difference ranging from approximately 0.1 volts to approximately 0.5 volts relative to a reference electrode. In other implementations the pulsed electrical bias may be defined in terms of current density differences, for example between approximately 5 mA/cm² and approximately 40 mA/cm². More broadly, the electrical operating conditions may fall within potential ranges from about 0.1 V to about 10 V depending on the electrochemical system, and current densities from about 0.1 mA/cm² to about 500 mA/cm² may be used in certain implementations. These electrical parameters may be selected to control the rate at which chemical precursors are converted into material growth species and to regulate nucleation behavior at the seed material.

The pulsed electrical bias may further be characterized by the duration of the higher-bias and lower-bias intervals. Each interval may have a duration selected to achieve desired electrochemical and material growth behavior. For example, the higher-bias interval may facilitate generation of reactive growth species, while the lower-bias interval may permit diffusion, stabilization, attachment, or rearrangement of the growing material structure. In certain embodiments, the duration of each interval may range from approximately 0.1 seconds to approximately 10 seconds. In other implementations, pulse durations may extend from microsecond-scale pulses to several minutes depending on the reactor configuration, electrode geometry, electrolyte composition, and target material properties. The pulsed electrical bias may therefore include pulse cycles having total durations ranging from approximately 0.1 seconds to approximately 10 seconds, although shorter or longer cycles may be used.

Additional parameters may also be used to characterize the pulsed electrical operation. These parameters may include duty cycle, waveform shape, repetition frequency, total delivered charge per pulse, and temporal sequencing of multiple pulse regimes. For example, the duty cycle may represent the fraction of each pulse cycle during which the higher-bias interval is applied. The waveform may be square, sinusoidal, triangular, trapezoidal, ramped, or irregular in shape. In some embodiments, the electrical control system may dynamically adjust the pulsed bias parameters during operation in order to optimize nucleation density, growth rate, material morphology, or structural properties of the synthesized material.

The pulsed electrochemical operation described herein may be implemented using a variety of electrode materials, electrolytes, and precursor chemistries. Pulsed electrical stimulation may influence the electrochemical environment at the electrode surface, including local concentration gradients, charge transfer kinetics, mass transport behavior, and formation of intermediate species. By periodically varying the electrical driving conditions, the system may promote controlled nucleation of material growth species on the seed material and regulate subsequent material growth through the self-seeding nucleation mechanisms described herein.

Material properties may be controlled by adjusting seed material characteristics, spatial patterning, pulse parameters, electrolyte composition, temperature, pH, and applied fields. For example, crystal structure, surface area, porosity, layer thickness, lateral dimensions, and defect density can all be influenced by these parameters. Growth rates and energy efficiency improvements achieved by the self-seeding nucleation process vary depending on the material system. As demonstrated in illustrative experimental data, graphene growth rates may increase by 2.66× with a 1.66× improvement in energy efficiency, carbon nanotubes may achieve a 4.12× growth rate increase with 2.81× improved energy efficiency, and porous carbon may reach 4.69× growth rates with 2.86× improved energy efficiency. The process also reduces the use of harmful chemicals by 60-87%, depending on the material.

Carbon fibers may be produced from aqueous electrolytes containing dissolved CO₂ or carbonate/bicarbonate precursors at room temperature to moderate temperatures (20-60 C) using 1.5-3.5 V and 5-25 mA/cm² on carbon-based seed filaments, enabling continuous filament production under ambient conditions.

Specific exemplary materials synthesized by the process include graphene, carbon nanotubes, carbon fibers, graphite, and porous carbon, each with defined electrolyte compositions, temperature ranges, voltage ranges, current densities, and seed materials. For example, graphene may be synthesized in an aqueous graphene oxide suspension (1-5 g/L) with NaCl (0.1 M) at 20-60° C. using 1.5-3.0 V and 5-20 mA/cm² on graphene oxide flakes. Carbon nanotubes may be synthesized in aqueous dispersions (0.5-2 g/L) with Na₂SO₄ (0.05 M) at 30-80° C. using 2.0-4.0 V and 10-30 mA/cm² on carbon nanotube fragments. Carbon fibers may be produced from polyacrylonitrile solutions (8-12% in DMF with 0.2 M LiCl) at 150-250° C. using 3.0-5.0 V and 15-40 mA/cm² on carbon fiber segments. Porous carbon may be synthesized from sucrose/phenolic resin solutions (5-15% with 0.1 M H₂SO₄) at 70-120° C. using 2.5-4.5 V and 8-25 mA/cm² on activated carbon particles. Graphite may be produced from graphite oxide suspensions (2-8 g/L with 0.15 M KCl) at 25-70° C. using 1.8-3.5 V and 10-35 mA/cm² on graphite particles. These illustrative examples are non-limiting and representative of the broad applicability of the method.

In some embodiments, the self-seeding nucleation method may be implemented in an electrochemical reactor configured to provide a controlled environment for precise material growth. The reactor may comprise a sealed reaction chamber, one or more electrodes including a cathode with a deposited seed material, and an electrolyte reservoir containing precursor species suitable for electrochemical conversion. The reactor may further include ports for introducing gaseous precursors, including carbon dioxide or other reactive gases, and for removing gaseous or liquid byproducts generated during the reaction. An electrical power source may be connected to the electrodes to supply a controlled current or potential, thereby driving the electrochemical reactions. The reactor may also incorporate systems for handling, recycling, or neutralizing reaction byproducts, ensuring efficient and safe operation.

In some embodiments, the complete reactor system may include additional components to further control reaction conditions and optimize material growth. For example, the reactor system may include a temperature control system to maintain desired thermal conditions, as well as monitoring and control systems configured to measure and adjust parameters such as voltage, current, pH, precursor concentration, and gas flow rates. The cathode, which supports the seed material, may serve as the primary site for nucleation and growth of the target material, while the anode completes the electrochemical circuit and may participate in side reactions or gas evolution. Electrolyte solutions may comprise aqueous or non-aqueous solvents, dissolved salts, polymer precursors, or suspended particles, alone or in combination, and may be circulated, replenished, or otherwise managed to maintain optimal reaction conditions.

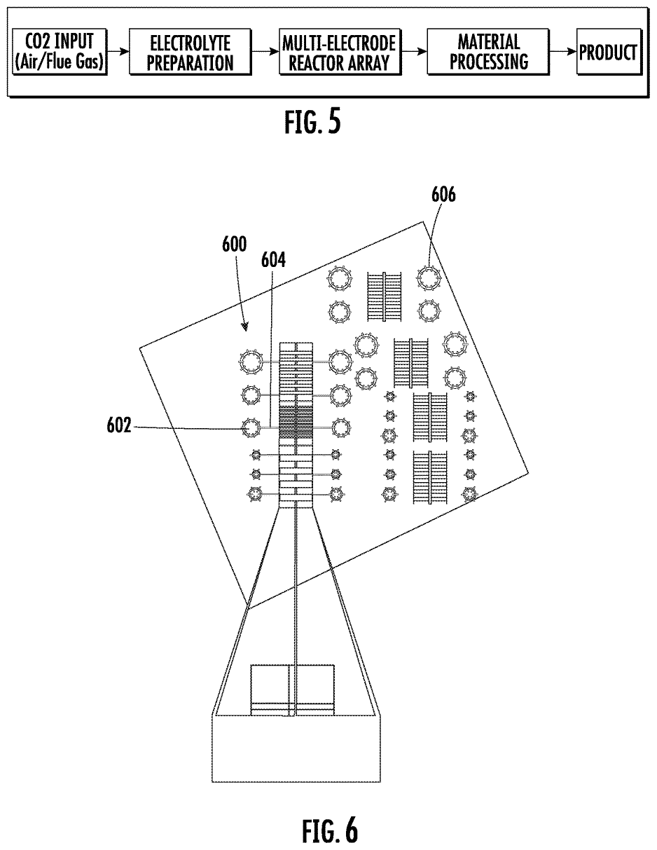

In embodiments, the seed material is electrically connected to the electrode such that the seed material participates directly in the electrochemical reaction occurring within the reactor. Electrical connection may be achieved through direct deposition of the seed material onto a conductive electrode surface, through conductive traces, or through intermediate conductive layers or contact pads. When electrically connected, the seed material can experience the local electrochemical potential applied to the electrode, thereby enabling nucleation of material growth species directly on the seed surface. This configuration can promote preferential nucleation at the seed locations and facilitate controlled initiation of the self-propagating growth mechanism described herein, as illustrated in the representative embodiment shown in FIG. 6.

In embodiments, the seed material may be patterned on the electrode surface to localize nucleation and growth of the synthesized material. Patterning enables spatial control over where material growth occurs within the electrochemical reactor. As shown in FIG. 6, electrically connected graphene pieces 602 are arranged in discrete patterns on the substrate 600, connected via conductive traces 604 to the electrode, while control samples 606 remain electrically isolated. Such patterned arrangements may be created using lithographic techniques, masking, printing, laser patterning, or other microfabrication or deposition methods capable of defining discrete seed regions on an electrode surface.

In embodiments, the seed material is deposited in predetermined patterns comprising multiple discrete seed features separated by regions substantially free of seed material. Each seed feature, such as the electrically connected graphene pieces 602 in FIG. 6, is electrically coupled to the electrode through conductive traces 604 or direct contact with the electrode surface. Upon application of an electrical current, nucleation occurs predominantly at the seed features, while the separation between features allows spatial isolation of growth events. Control regions 606 that are electrically isolated from the electrode serve as reference sites for comparison of electrochemically activated versus passive nucleation.

The seed features may have various geometries, including rings, stripes, circular pads, grids, lattices, or dots. The geometry, spacing, and orientation of the seed features can influence the morphology and propagation of the resulting material growth. For example, elongated seed features such as stripes may promote directional growth, while circular or ring-shaped features may encourage radial nucleation and branching. FIG. 6 provides a representative layout in which multiple geometries are present, illustrating both electrically connected and isolated seed regions on a single substrate.

In certain embodiments, each seed feature is independently electrically connected to the electrode to enable localized participation in the electrochemical reaction. As shown in FIG. 6, the electrically connected graphene pieces 602 function as active nucleation sites, while the electrically isolated control samples 606 verify that growth occurs primarily due to electrochemical activation rather than passive deposition. Such configurations allow for precise evaluation of the self-seeding nucleation mechanism, optimization of growth parameters, and controlled placement of the synthesized material on the substrate 600.

In embodiments, the patterned seed structures described with reference to FIG. 6 are integrated within the general electrochemical reactor design illustrated in FIGS. 1-5. The substrate 600 with discrete, electrically connected seed features 602 can be positioned within the reactor 100 such that pulsed or otherwise controlled electrochemical conditions are applied to the electrode surfaces. The reactor configuration, including fluidic pathways, counter and reference electrodes, and any temperature or flow control elements shown in FIG. 1, provides the environment in which localized nucleation and growth occur at the seed sites. By combining the pulsed electrochemical activation of the electrode with the patterned arrangement of seed features, precise spatial and temporal control over material synthesis is achieved, enabling reproducible self-seeding nucleation and propagation across the substrate. Control regions 606 electrically isolated from the electrode allow comparison of electrochemically activated growth to passive deposition, thereby validating the influence of both reactor conditions and seed patterning on the resulting material morphology.

In some embodiments, the reactor configuration and associated systems may be modified or scaled according to the desired material type, growth rate, or morphology. The system may accommodate multiple electrodes, varied electrode geometries, or alternative gas delivery mechanisms. The reaction chamber may be configured to allow modular insertion of additional process components, including filtration units, separators, or sensors. Likewise, the power source may provide pulsed, continuous, or programmed electrical signals to control nucleation kinetics and material properties. Such flexibility enables the self-seeding nucleation process to be adapted for the synthesis of a wide range of materials, including carbon-based materials, metals, semiconductors, and composites, while maintaining control over growth, morphology, and functional properties.

The process also offers substantial environmental benefits. By utilizing CO₂ from ambient air or industrial emissions as a feedstock, the method reduces greenhouse gas emissions while generating high-value carbon materials. Water consumption, solvent use, and hazardous waste generation are reduced compared to conventional synthesis methods. Energy consumption is reduced by 40-65% depending on the material, and process byproduct recovery is increased from approximately 25% to 68%, providing additional sustainability advantages.

In addition to the environmental benefits described above, the self-seeding nucleation method provides a direct route for carbon capture and utilization. CO₂ from ambient air or industrial emissions may be introduced through the gas inlet 110 into the reactor, as shown in FIG. 5, where it participates in electrochemical reduction and subsequent material nucleation on the seed electrode

Carbon dioxide, sourced from ambient air, industrial flue gases, or emissions from power plants and manufacturing facilities, can be introduced into the electrochemical reactor as a carbon precursor. Within the reactor, CO₂ is electrochemically reduced in the presence of an aqueous electrolyte and catalytic electrodes bearing seed material, enabling the nucleation and growth of carbon nanostructures directly from the captured CO₂. This approach allows for the synthesis of high-value carbon-based materials, including graphene, carbon nanotubes, carbon fibers, graphite, and porous carbon structures, without the need for hazardous chemical precursors typically used in conventional methods. By simultaneously converting a greenhouse gas into valuable products, the method achieves a dual benefit of reducing atmospheric CO₂ levels and generating commercially relevant carbon materials. Compared to traditional high-temperature synthesis techniques, this approach operates at substantially lower temperatures, uses aqueous electrolytes rather than aqueous or hydrocarbon feedstocks, and generates oxygen as a co-product rather than CO₂ as a waste stream. Moreover, the flexibility of the system allows CO₂ utilization to be tailored to different material targets, reactor configurations, and process scales, making the method broadly applicable for both environmental mitigation and industrial material production.

Table 1 provides a non-limiting overview of example material systems that may be synthesized using the disclosed electrochemical self-seeding nucleation process. The table summarizes representative materials, example precursor chemistries, seed materials, and general operating conditions that may be used for synthesis. The materials and parameters listed in Table 1 are illustrative examples intended to demonstrate the versatility of the disclosed systems and methods and should not be interpreted as limiting the scope of the invention.

TABLE 1
Computational Analysis of Material Efficiency

| | | Reduction of | |
|---|---|---|---|
| | Efficiency | Harmful | Growth Rate |
| Material | Increase (X) | Chemicals (%) | Increase (X) |
| Graphene | 1.66 | 85.2 | 2.66 |
| Carbon Nanotubes | 2.81 | 66.5 | 4.12 |
| Carbon Fiber | 2.11 | 68.1 | 3.22 |
| Porous Carbon | 2.86 | 86.8 | 4.69 |
| Graphite | 1.65 | 60.7 | 4.07 |

Table 2 illustrates representative electrolyte compositions that may be used in connection with the synthesis of different classes of materials. Table 2 also provides example operating ranges for electrical parameters that may be applied during electrochemical synthesis. The electrolyte compositions may include aqueous or non-aqueous solvents, dissolved salts, organic molecules, polymer precursors, suspended particles, or combinations thereof. These compositions may facilitate electrochemical conversion of precursor species into material growth species capable of nucleating on the seed material.

In embodiments, the electrolyte compositions used in the electrochemical synthesis processes described herein may include a wide variety of liquid or quasi-liquid media capable of supporting electrochemical reactions and transport of precursor species. The electrolyte may comprise aqueous electrolytes, organic solvent-based electrolytes, mixed solvent systems, ionic liquid electrolytes, polymer electrolytes, gel electrolytes, or combinations thereof. The electrolyte may further include dissolved salts, acids, bases, buffers, supporting electrolytes, organic molecules, polymer precursors, suspended particles, dispersed nanomaterials, gaseous precursors dissolved in the electrolyte, or other chemical species capable of participating in electrochemical reactions. In certain implementations, the electrolyte contains carbon-containing precursors such as graphene oxide suspensions, carbon nanotube dispersions, graphite oxide suspensions, polymer-derived carbon precursors, sugars, phenolic resins, hydrocarbons, alcohols, carbon monoxide, carbon dioxide, or combinations thereof. The electrolyte composition may therefore be selected based on the desired material system, precursor chemistry, reactor configuration, and electrochemical operating conditions. The electrolyte compositions summarized in Table 2 represent representative examples of such systems and are not intended to limit the scope of electrolyte formulations that may be used in connection with the self-seeding nucleation processes described herein.

For the purposes of this disclosure, “graphene” refers to single- or few-layer sheets of sp²-bonded carbon atoms, which may be provided as discrete “graphene oxide flakes” suspended in aqueous solution. “Carbon nanotubes” refers to cylindrical allotropes of carbon, including single- or multi-walled varieties, which may be provided as short segments or “carbon nanotube flakes” dispersed in aqueous electrolytes. “Carbon fiber” refers to fibers derived from polyacrylonitrile (PAN) precursors, typically provided as short “carbon fiber segments” in solution. “Porous carbon” refers to carbonaceous materials with high surface area and interconnected porosity, which may include “activated carbon particles” prepared from polymer or sugar-derived precursors. “Graphite” refers to layered crystalline carbon, which may be supplied as particulate “graphite particles” or oxidized “graphite oxide” suspensions. In each case, the terms “suspension” or “solution” refer to a medium in which the material is dispersed or dissolved along with supporting electrolytes or salts, which facilitate the electrochemical reactions required for material growth.

TABLE 2
Process Parameters for Various Material Systems

| | | | Voltage | Current | |
|---|---|---|---|---|---|
| | Electrolyte | Temperature | Range | Density | Seed |
| Material | Composition | Range (° C.) | (V) | (mA/cm²) | Material |
| Graphene | Aqueous | 20-60 | 1.5-3.0 | 5-20 | Graphene |
| | graphene | | | | oxide |
| | oxide | | | | flakes |
| | suspension | | | | |
| | (1.5 g/L) | | | | |
| | with NaCl | | | | |
| | (0.1M) | | | | |
| Carbon | Aqueous | 30-80 | 2.0-4.0 | 10-30 | Carbon |
| Nanotubes | carbon | | | | nanotube |
| | nanotube | | | | flakes |
| | suspension | | | | |
| | (0.5-2 g/L) | | | | |
| | with NaSO₄ | | | | |
| | (0.05M) | | | | |
| Carbon | Aqueous | 20-60 | 1.5-3.5 | 5-25 | Carbon- |
| Fiber | electrolyte | | | | based |
| | with | | | | seed |
| | dissolved | | | | filaments |
| | CO2 and | | | | |
| | supporting | | | | |
| | bicarbonate | | | | |
| | salt | | | | |
| | (0.1-0.5M) | | | | |
| Porous | Aqueous | 20-60 | 1.5-3.5 | 5-25 | Activated |
| Carbon | electrolyte | | | | carbon |
| | with | | | | particles |
| | dissolved | | | | |
| | CO2 and | | | | |
| | supporting | | | | |
| | bicarbonate | | | | |
| | salt | | | | |
| | (0.1-0.5M) | | | | |
| Graphite | Graphite | 25-70 | 1.8-3.5 | 10-35 | Graphite |
| | oxide | | | | particles |
| | suspension | | | | |
| | (2-8 g/L) | | | | |
| | with KCL | | | | |
| | (0.15M) | | | | |

Table 3 compares the energy consumption of conventional synthesis methods with the self-seeding nucleation method for various carbon-based materials. Across all materials listed—graphene, carbon nanotubes, carbon fiber, porous carbon, and graphite—the self-seeding method demonstrates a significant reduction in energy usage. Specifically, energy consumption is reduced from 120.5 to 72.6 kWh/kg for graphene, 185.3 to 65.9 kWh/kg for carbon nanotubes, 156.8 to 74.3 kWh/kg for carbon fiber, 98.7 to 34.5 kWh/kg for porous carbon, and 110.2 to 66.8 kWh/kg for graphite, corresponding to energy savings ranging from approximately 39% to 65%. These results illustrate that the self-seeding method provides a more energy-efficient route for synthesizing a variety of carbon-based materials.

TABLE 3
Energy Efficiency Comparison

| | Conventional | Self-Seeding | |
|---|---|---|---|
| | Method Energy | Method Energy | |
| | Consumption | Consumption | Energy Savings |
| Material | (kWh/kg) | (kWh/kg) | (%) |
| Graphene | 120.5 | 72.6 | 39.8 |
| Carbon Nanotubes | 185.3 | 65.9 | 64.4 |
| Carbon Fiber | 156.8 | 74.3 | 52.6 |
| Porous Carbon | 98.7 | 34.5 | 65.0 |
| Graphite | 110.2 | 66.8 | 39.4 |

Table 4 compares key material properties of various carbon-based materials synthesized using conventional methods versus the self-seeding nucleation method. For graphene, the self-seeding method reduces sheet resistance from 280.5 to 125.2 Q/sq and increases transparency from 87.3% to 91.6%, representing improvements of 55.4% and 4.9%, respectively. Carbon nanotubes show significant enhancements in tensile strength and electrical conductivity, increasing from 1.8 to 3.2 GPa (77.8%) and from 1.2×10⁵ to 3.5×10⁵ S/m (191.7%), respectively. Carbon fiber exhibits higher tensile strength and elastic modulus, improving by 37.1% and 34.8%. Porous carbon demonstrates substantially increased surface area and pore volume, with improvements of 74.4% and 94.1%. Graphite shows notable increases in electrical and thermal conductivity, improving by 120.0% and 60.7%, respectively. Overall, the self-seeding method consistently enhances the functional properties of all materials compared to conventional synthesis techniques.

TABLE 4
Material Property Comparison

| | | Conventional | Self-Seeding | Improvement |
|---|---|---|---|---|
| Material | Property | Method | Method | (%) |
| Graphene | Sheet | 280.5 | 125.2 | 55.4 |
| | Resistance | | | |
| | (Ω/sq) | | | |
| Graphene | Transparency | 87.3 | 91.6 | 4.9 |
| Carbon | Tensile | 1.8 | 3.2 | 77.8 |
| Nanotubes | Strength (GPa) | | | |
| Carbon | Electrical | 1.2 × 10⁵ | 3.5 × 10⁵ | 191.7 |
| Nanotubes | Conductivity | | | |
| | (S/m) | | | |
| Carbon | Tensile | 3.5 | 4.8 | 37.1 |
| Fiber | Strength (GPa) | | | |
| Carbon | Elastic | 230 | 310 | 34.8 |
| Fiber | Modulus (GPa) | | | |
| Porous | Pore Volume | 0.85 | 1.65 | 94.1 |
| Carbon | (cm³/g) | | | |
| Porous | Surface Area | 1250 | 2180 | 74.4 |
| Carbon | (m²/g) | | | |
| Graphite | Electrical | 1.0 × 10⁴ | 2.2 × 10⁴ | 120.0 |
| | Conductivity | | | |
| | (S/m) | | | |
| Graphite | Thermal | 140 | 225 | 60.7 |
| | Conductivity | | | |
| | (W/m*K) | | | |

Table 5 illustrates the scaling characteristics of the self-seeding nucleation process across bench, pilot, and industrial scales. Reactor volumes increase from 0.5-5 L at the bench scale to 50-500 L at the pilot scale and up to 1,000-50,000 L at the industrial scale, with corresponding production rates ranging from 0.01-0.1 kg/day to 100-1,000 kg/day. Key performance metrics, including energy efficiency retention, growth rate retention, and quality consistency, remain high across scales, with only modest reductions observed at larger volumes. Specifically, energy efficiency retention decreases from 100% at bench scale to 89% at industrial scale, growth rate retention decreases from 100% to 92%, and quality consistency decreases from 99% to 95%. Economic metrics also improve with scale, as capital cost per kilogram of capacity declines from approximately $12,000 at bench scale to $1,800 at industrial scale, while operating costs decrease from $280/kg to $85/kg. These results demonstrate that the self-seeding nucleation method is scalable while maintaining efficient, consistent, and high-quality material production.

TABLE 5
Scalability Analysis

| | Bench | Pilot | Industrial |
|---|---|---|---|
| Parameter | Scale | Scale | Scale |
| Reactor Volume (L) | 0.5-5 | 50-500 | 1,000-50,000 |
| Production Rate (kg/day) | 0.01-01 | 1-10 | 100-1,000 |
| Energy Efficiency Retention (%) | 100 | 94 | 89 |
| Growth Rate Retention (%) | 100 | 97 | 89 |
| Quality Consistency (%) | 99 | 97 | 95 |
| Capital Cost (kg/capacity) | 280 | 155 | 85 |
| [12,000[15,000[1,800]] Operating | | | |
| Cost (kg) | | | |

Table 6 illustrates representative parameters that can be adjusted to control the morphology of materials synthesized via the self-seeding nucleation method. The size and distribution of the seed material influence nucleation density and growth uniformity and may be controlled through selection of seed size and deposition techniques such as spray, dip, or spin coating. Electrical parameters, including current density and pulsing characteristics, can modulate growth rate, branching, and layer formation, and may be adjusted using programmable power supplies. Chemical parameters, including electrolyte concentration and pH, affect material thickness, density, and surface functionalization and may be regulated using real-time monitoring and buffering systems. Physical parameters such as temperature and externally applied fields, including electric, magnetic, or acoustic fields, can impact crystallinity, defect density, and growth orientation and may be controlled via multi-zone temperature systems or field-generating equipment. Collectively, these parameters enable precise and tunable control over material morphology to achieve desired structural and functional properties.

TABLE 6
Morphological Control Parameters

| Control | | |
|---|---|---|
| Parameter | Effect on Morphology | Adjustment Method |
| Seed Material | Determines initial | Selection of appropriate size |
| Size | nucleation density | distribution during seed |
| | | preparation |
| Seed Material | Affects uniformity | Optimized deposition method |
| Distribution | of growth | (spray, dip, spin coating) |
| Current | Controls growth rate | Precise power supply with |
| Density | and branching | programmable current profiles |
| Electrolyte | Influences thickness | Real-time monitoring and |
| Concentration | and density | adjustment systems |
| Temperature | Affects crystallinity | Multi-zone temperature control |
| | and defect density | system |
| pH | Directs growth | Superimposed electric, magnetic |
| | orientation | or acoustic fields |
| Pulse | Controls layer | Programmable pulse width and |
| Parameters | formation | frequency |

### EXAMPLES

### Prophetic Example 1—Proof-of-Concept Aqueous CO₂ Electrochemistry with Patterned Graphene Seeds

The following prophetic experimental examples are intended to illustrate the application of the self-seeding nucleation process in an intended proof-of-concept demonstration using patterned graphene seed structures to produce localized carbon growth from CO₂ in aqueous electrolytes.

In these experiments, patterned graphene seed features (circular and stripe geometries) will be electrically connected to the electrode and subjected to pulsed electrochemical conditions. It is expected that the pulsed bias sequences, comprising alternating higher- and lower-bias intervals (e.g., P1-P3 regimes), will provide localized electrochemical environments that selectively promoted nucleation at the seed material while limiting non-specific deposition on electrically isolated control features. This result would directly correlate with the invention's approach of applying pulsed electrical stimulation to control nucleation and growth kinetics at the electrode surface.

Specifically, the experimental pulse parameters—on-time, off-time, duty cycle, and relative potential differences—exemplify the ranges and principles described in [0021]-[0023], including bias differences of approximately 0.2-0.4 V and current densities of 5-40 mA/cm². By applying these controlled pulse sequences, reactive growth species may be generated preferentially at the electrically connected seed features, resulting in reproducible, localized carbon deposition from CO₂. The separation between seed features and the inclusion of electrically isolated control geometries will allow direct evaluation of the self-seeding nucleation mechanism, demonstrating that growth occurred predominantly due to electrochemical activation rather than passive deposition.

These experiments will illustrate how the invention enables spatial and temporal control over material synthesis by integrating patterned seed structures, electrical connectivity, and pulsed electrochemical stimulation. The experimental results will validate the design principles outlined in [0020]-[0023], showing that morphology, nucleation density, and growth direction can be tuned through seed patterning, pulsed bias selection, and localized electrical activation. Furthermore, the examples will provide a proof-of-concept for scalable implementation, in which multiple seed features on a single substrate can be independently activated within a controlled reactor environment, consistent with the broader embodiments described above.

### Prophetic Experimental Set-Up

A pathfinder chip (Chip ID NNQ_2II) will be fabricated containing multiple electrically connected graphene seed geometries, including 12 circular features (CR1-CR6, CL1-CL6) and 21 stripe features (S01-S07, S10-S19, S21-S24), as well as control geometries (16 rings, 22 stripes) electrically disconnected but exposed to the same electrolyte. Each feature will be treated as an experimental unit for seeded-versus-control comparisons. Each seeded feature will be electrically connected to the electrode via conductive traces or direct contact, while control features will be electrically isolated.

### Prophetic Baseline and Shakedown Procedures

Prior to experimental runs, a dummy chip without graphene will be used to validate mechanical and sealing performance of the electrode holder. Electrolyte (aqueous solution containing CO₂ precursors) will be introduced, and open-circuit potential will be monitored for 10-15 minutes to ensure stability. Small test biases of +50 mV around OCP will confirm stable electrical contact without unintended reactions. Any instability, leakage, or delamination will be corrected before proceeding to the pathfinder chip.

### Prophetic Electrochemical Run and Pulse Regimes

The experimental procedure will employ a “scouting ladder” to identify a stable cathodic operating point that produces measurable deposition on seeded features without excessive hydrogen evolution or current instability. This involves stepwise increases of the driving force in 2-4 increments, with 2-3 minute holds per step. The working potential/current selected (E_on/I_on) will be documented along with bubble coverage, current stability, and visual inspection.

Once the operating point will be selected, pulsed operation will be applied in three regimes:

P1 (seed-selective)-slow deposition to maximize localization: t_on=0.2-0.5 s, t_off=4-10 s, duty cycle 2-10%, E_off set 0.2-0.4 V less cathodic than E_on (or I_off=0 if current-controlled). Target charge: 0.1-0.5 C/cm². Used when deposition appears broad or for better seeded-vs-control contrast.

P2 (baseline)-balanced growth and stability: t_on=1 s, t_off=4 s, duty cycle ~20%, E_off 0.3 V less cathodic than E_on (or I_off=0). Target charge: 0.5-2 C/cm². First “real” growth run.

P3 (growth-forward, optional)-ensure detectable growth: t_on=5-10 s, t_off=0-5 s, duty cycle 50-100%, E_off 0.2 V less cathodic than E_on (or I_off=0). Target charge: 2-5 C/cm². Applied only if P1/P2 produce weak seeded growth.

Adjustments to E_on/I_on, t_on, and t_off will be made if strong bubble coverage, noisy current, or nonspecific darkening occurred. Total delivered charge (Q) will be used as the primary stop criterion to allow comparability across runs.

### Prophetic Data Acquisition and Characterization

During each run, full current-time traces will be recorded, and total charge delivered to each feature will be calculated. Pre- and post-run optical images will be captured for each feature, and Raman spectroscopy and/or SEM will be used when available to characterize the morphology and confirm the presence of carbon growth. Optional \hat{ }13CO₂ labeling experiments will be performed to confirm the carbon source and strengthen IP defensibility. Electron accounting and first-pass Faradaic efficiency will be estimated using total charge and observed mass of carbon deposited, allowing calculation of carbon-to-product conversion with wide error bars noted for preliminary experiments.

### Prophetic Results

Seeded features are expected to demonstrate localized material growth, including measurable changes in thickness, optical properties, and Raman signatures, while electrically disconnected control features are expected to exhibit minimal or no deposition under the same conditions. Pulsed operation is expected to limit nonspecific deposition. The formation of additional nucleation sites emanating from initial graphene seed patterns may indicate a self-seeding nucleation mechanism. These experiments are expected to provide quantitative contrasts in material growth between seeded and control features and demonstrate the ability to selectively control morphology through patterning, pulsing, and electrical connectivity.

### Prophetic Post-Run Handling

After each run, electrodes will be rinsed with deionized water, dried with nitrogen, and imaged to preserve structural integrity. Raman and SEM mapping will be performed on representative seeded and control features. All experimental runs will be documented, including run ID, operator, chip ID, feature IDs, electrolyte composition, CO₂ flow rates, pulse parameters, and total charge delivered.

### Prophetic Conclusion of Example 1

These experiments are expected to provide evidence that the self-seeding nucleation method enables precise, localized control of material growth, reproducible morphology tuning, and efficient carbon utilization from CO₂ sources. The process will demonstrate scalability to multiple features and, by extension, industrial-scale reactor implementations. The methods described in these examples are non-limiting illustrations, and variations in seed materials, patterns, pulse parameters, electrolytes, voltages, current densities, temperatures, and applied fields are all within the scope of the invention.

### Example 2

The objective of these tests was to evaluate whether graphitic carbon seed materials, including graphene and graphene oxide, influence electrochemical carbon deposition from carbon dioxide-derived precursors under aqueous electrochemical conditions. In particular, the study sought to determine whether such seed materials promote nucleation and/or growth of carbon on a copper electrode relative to unseeded conditions.

Electrochemical conditions were selected based on prior reports indicating that carbon deposition detectable by Raman spectroscopy may be obtained following extended electrolysis at cathodic potentials in aqueous bicarbonate electrolytes.

### Materials

Copper electrodes were prepared from annealed copper sheet (approximately 99.9% purity, approximately 1 mm thickness). Electrodes were cut into pieces approximately 2.5 cm×1 cm. Graphene oxide dispersions (approximately 2 mg/mL in water) and graphene nanoplatelet dispersions (approximately 1 mg/mL in N-methyl-2-pyrrolidone (NMP)) were used as seed materials. The electrolyte comprised an aqueous solution of potassium bicarbonate (approximately 0.5 M KHCO₃). Carbon dioxide was supplied via sparging.

Electrochemical measurements were performed using a potentiostat with a three-electrode configuration including: a copper working electrode, a platinum wire counter electrode, and a silver/silver chloride reference electrode (approximately 3.5 M KCl).

### Preparation

Copper electrodes were mechanically flattened and cleaned prior to use. Cleaning included sonication for approximately 1 minute in: aqueous hydrochloric acid (approximately 1 M), deionized water, and in some cases, isopropyl alcohol (IPA). Following cleaning, electrodes were dried prior to seed deposition.

Graphene oxide seeds were deposited by drop-casting approximately 5 μL of graphene oxide dispersion onto the copper surface. In some instances, templates comprising openings of approximately 3 mm diameter were used to define seed geometry. The dispersion was allowed to dry under ambient conditions. After deposition, masking was applied to the electrode surface to expose an area of approximately 1 cm×1 cm including the seed. Masking materials included PTFE tape or epoxy resin.

Graphene nanoplatelet seeds were deposited by drop-casting approximately 5 μL of graphene dispersion onto the copper surface. The electrodes were then heated at approximately 80° C. for approximately 2 hours to remove solvent. After cooling, epoxy masking was applied to define the exposed electrode area. Lower-concentration dispersions were used in certain experiments to produce thinner seed layers.

Seeded copper electrodes were placed in an electrochemical cell containing a platinum wire counter electrode polished with alumina slurry, and a silver/silver chloride reference electrode. The electrolyte (approximately 0.5 M KHCO₃) was sparged with carbon dioxide for approximately 15 minutes prior to electrolysis while stirring at approximately 400 rpm. Stirring was then stopped while sparging was continued during electrolysis.

### Constant-Potential Electrolysis

Electrolysis was performed at approximately-1.408 V versus the reference electrode for approximately 10,800 seconds (approximately 3 hours). Following electrolysis, electrodes were rinsed with deionized water, air-dried, and analyzed.

In pulsed electrolysis experiments, a pre-pulse at approximately-2 V was applied for approximately 4 seconds. Following the pre-pulse, either: constant electrolysis at approximately-1.408 V was applied, or a pulsed program was applied comprising: higher-bias intervals at approximately-1.408 V, and lower-bias intervals at approximately-0.4 V or approximately-1.0 V. Pulse durations were approximately 4 seconds for each interval.

In certain experiments, pulsing conditions were adjusted to reduce re-oxidation currents observed during operation. Carbon dioxide sparging during pulsed experiments was achieved using sublimation of solid carbon dioxide, resulting in variable gas delivery rates.

### Raman Characterization

Following electrolysis, Raman spectroscopy was performed on seeded and unseeded regions. One-dimensional Raman maps were collected extending from the edge of the seed region to distances of up to approximately 1.5 mm. Spectra were analyzed for D-band and G-band features characteristic of graphitic carbon materials. Background correction was applied to enable comparison of spectral intensities.

### Results—Graphene Oxide Seeds

Of multiple graphene oxide seed samples, a subset produced Raman signals sufficient for analysis. In at least one sample, visible thickening of the seed region was observed following electrolysis. However, this effect was not consistently reproducible across samples.

Raman mapping of electrochemically treated samples showed strong carbon-related signals within the seed region. In some cases, weak signals were detected at locations beyond the seed boundary, although such signals were near the detection limit and may be attributable to residual material or experimental artifacts. Control samples that were not subjected to electrolysis exhibited a rapid decrease in Raman signal intensity with distance from the seed edge. Changes in the relative intensity of D-band and G-band features were observed following electrolysis, indicating modification of the carbon material.

### Results—Graphene Seeds

Graphene nanoplatelet seeds generally remained adhered to the electrode surface during electrolysis. Raman spectra of electrochemically treated graphene seeds showed increased D-band intensity relative to G-band intensity compared to untreated samples, indicating structural modification of the carbon material. Raman mapping indicated strong signals within the seed region and generally weak or absent signals outside the seed region. In certain instances, weak signals were observed extending up to several hundred microns from the seed boundary, although these signals were not consistently reproducible and were near the noise threshold.

Both constant and pulsed electrolysis conditions resulted in observable modification of the seed material. Pulsed electrolysis produced transient current responses, including re-oxidation currents during lower-bias intervals.

### Unseeded Controls

No detectable carbon deposition was observed on unseeded copper regions under the tested electrochemical conditions. This observation was consistent across multiple experiments.

### Experimental Variability and Observations

Variability in experimental outcomes was attributed to several factors, including: seed thickness and uniformity, adhesion of seed material to the electrode, surface preparation and oxidation state of the copper, masking integrity and electrolyte intrusion, and variability in carbon dioxide delivery during sparging. In some instances, electrolyte intrusion beneath masking layers may have influenced local reaction conditions, including the formation of reactive intermediates.

The presence of carbon-related Raman signals at seeded regions and the absence of such signals on unseeded copper surfaces indicate that conductive seed materials influence electrochemical carbon formation. Modification and occasional thickening of seed regions suggest interaction between electrochemically generated species and the seed material. While reproducible outward growth beyond the seed boundary was not conclusively demonstrated under the tested conditions, the observed behavior is consistent with nucleation occurring preferentially at seeded regions, and in certain instances suggesting formation of additional nucleation sites associated with the seed material.

These experiments demonstrate that graphitic seed materials, including graphene and graphene oxide, influence electrochemical carbon deposition behavior under aqueous CO₂-containing conditions. The results support the role of conductive seed materials in facilitating nucleation and modification of carbon-based materials at electrode surfaces, consistent with the methods and systems described herein.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

1. A method of synthesizing a material comprising:
depositing a conductive seed material onto, or in proximity with, an electrode within an aqueous electrochemical reactor;
introducing into the reactor an aqueous electrolyte containing one or more chemical precursors;
applying a pulsed electrical current or potential to the electrode to convert the chemical precursors into material growth species; and
nucleating the material growth species on the seed material such that the seed material initiates growth of a solid material.

2. The method of claim 1, wherein the material growth species forms additional nucleation sites that promote continued growth of the solid material.

3. The method of claim 1, wherein the seed material comprises a carbon-based material.

4. The method of claim 3, wherein the carbon-based material comprises graphene, graphene oxide, carbon nanotubes, carbon fibers, graphite, nanodiamonds, or combinations thereof.

5. The method of claim 1, wherein the seed material comprises a conductive metal.

6. (canceled)

7. (canceled)

8. (canceled)

9. The method of claim 1, wherein the pulsed electrical current or potential comprises alternating higher-bias intervals and lower-bias intervals.

10. The method of claim 9, wherein the higher-bias interval comprises a bias magnitude within a first specified range and the lower-bias interval comprises a bias magnitude within a second specified range different from the first range.

11. (canceled)

12. (canceled)

13. (canceled)

14. (canceled)

15. (canceled)

16. (canceled)

17. (canceled)

18. (canceled)

19. The method of claim 1, further comprising operating the aqueous electrochemical reactor at a temperature between about 0° C. and about 400° C.

20. (canceled)

21. The method of claim 1, further comprising operating the aqueous electrochemical reactor at a pressure of about 0.1 bar to about 200 bar absolute.

22. (canceled)

23. (canceled)

24. (canceled)

25. (canceled)

26. (canceled)

27. (canceled)

28. (canceled)

29. (canceled)

30. An electrochemical reactor for synthesizing a material, comprising:
a sealed reaction chamber;
an electrode;
a conductive seed material deposited on, or in proximity with, the electrode;
a delivery system for introducing an aqueous electrolyte comprising one or more chemical precursors; and
a power supply configured to (i) apply a pre-pulse electrical treatment to the electrode to activate the conductive seed material by modifying its chemical or electronic state, and (ii) apply a pulsed electrical current or potential to the electrode to convert the chemical precursors into material growth species.

31. The electrochemical reactor of claim 30, wherein the power supply is configured to nucleate the material growth species on the seed material.

32. The electrochemical reactor of claim 30, wherein the pulsed electrical current or potential comprises alternating higher-bias intervals and lower-bias intervals.

33. (canceled)

34. (canceled)

35. (canceled)

36. (canceled)

37. The electrochemical reactor of claim 30, wherein the electrochemical reactor is configured to operate at a temperature between about 0° C. and about 400° C.

38. (canceled)

39. The electrochemical reactor of claim 30, wherein the electrochemical reactor is configured to operate at at a pressure of about 0.1 bar to about 200 bar absolute.

40. (canceled)

41. (canceled)

42. (canceled)

43. (canceled)

44. (canceled)

45. (canceled)

46. (canceled)

47. (canceled)

48. (canceled)

49. A method of synthesizing a material comprising:
depositing a conductive seed material onto, or in proximity with, an electrode within an electrochemical reactor;
introducing into the electrochemical reactor an electrolyte comprising one or more chemical precursors;
applying an electrical current or potential to the electrode to convert the chemical precursors into material growth species; and
nucleating the material growth species on the conductive seed material such that the conductive seed material initiates growth of a solid material, wherein the electrochemical reactor operates at a temperature between about 0° C. and about 400° C.

50. The method of claim 49, wherein the electrolyte comprises a deep eutectic solvent formed from a hydrogen bond acceptor and a hydrogen bond donor.

51. The method of claim 50, wherein the deep eutectic solvent comprises a choline chloride-based solvent.

52. The method of claim 49, wherein the electrochemical reactor operates at a pressure between about 0.1 bar and about 200 bar absolute.

53. The method of claim 49, wherein the electrolyte comprises an aqueous electrolyte and the electrochemical reactor operates at a temperature between about 80° C. and about 250° C. and a pressure between about 2 bar and about 40 bar absolute.

54. The method of claim 49, wherein the electrolyte comprises an ionic liquid and the electrochemical reactor operates at a temperature between about 80° C. and about 300° C.

55-76. (canceled)
